(19) United States
(12) Patent Application Publication
(10) Pub. No.: US 2014/0214475 A1
(43) Pub. Date: Jul. 31, 2014

(54) PARTITIONING JOB REQUIREMENTS FOR RESOURCE PLANNING

(71) Applicant: HEWLETT-PACKARD DEVELOPMENT COMPANY, L.P., Houston, TX (US)

(72) Inventors: Cipriano A. Santos, Modesto, CA (US); Juan Orozco Guzman, Guadalajara (MX); Maria Teresa Gonzalez Diaz, Mountain View, CA (US)

(73) Assignee: Hewlett-Packard Development Company, L.P., Houston, TX (US)

(21) Appl. No.: 13/753,669

(22) Filed: Jan. 30, 2013

(51) Int. Cl. G06Q 10/06

(52) U.S. Cl. CPC G06Q 10/06315
USPC 705/7.25

(57) ABSTRACT

Partitioning job requirements for resource planning can include identifying resource capacity and matching scores of a resource pool for a resource planning horizon, partitioning a full-time equivalent (FTE) job requirement into a plurality of positions based on the resource capacity and matching scores of the resource pool for the resource planning horizon using a computing device, and performing resource planning by allocating the resource capacity to the plurality of positions

### BACKGROUND

An enterprise, such as a business entity, can manage activities within the enterprise using resource planning. For instance, resource planning can be used to match available resources to jobs within an enterprise. Resources can, for example, refer to human and non-human resources (e.g., people, equipment, buildings, vehicles, services, and/or assets). A job can include any function to which a resource can be assigned.

For example, service enterprises employ service professionals to deliver a variety of services to customers and use resource planning to allocate workforce resources. During resource planning, service enterprises consider a number of objectives including increasing billable utilization of the work force, reducing overall labor costs, and matching job requirements with employee qualifications.

### BRIEF DESCRIPTION OF THE DRAWINGS

FIG. 1 is a block diagram illustrating an example of a method for partitioning a job requirement for resource planning according to the present disclosure.

FIG. 2 is a flow chart illustrating an example of a process for partitioning job requirements for resource planning according to the present disclosure.

FIG. 3 illustrates an example of a system according to the present disclosure.

### DETAILED DESCRIPTION

Allocating resources within an enterprise, such as an organization and/or company, through resource planning can increase the profitability of the enterprise. Resource planning can include providing a workforce resource with the right skills for the right job at the right time at the right cost. Resource planning can allow for efficient identification and prevention of current and future gaps between an available resource and a resource that can be used to deliver a project. Resource planning can match resources to jobs across an entire enterprise, which can lower the operating cost of operating the enterprise as compare to matching resources in an ad-hoc and/or decentralized manner.

Further, resource planning can match a resource to a job by considering the lowest cost to match the resource to the job. For example, a human resource can be matched to an available job by considering the capability of the human resource and the job requirements, the availability of the human resource, the training cost, and hiring policies.

In some instances, resource planning can allow for satisfaction of full-time equivalent (FTE) job requirements, while considering fractional resource capacity. FTE can include a certain portion of a full time assignment according to customs in the geographic location of the resource. For example, in some locations, a workweek may be defined as having 40 hours per week, while other locations may define a workweek as 37 hours per week. An FTE of 1 can indicate a full time resource, and an FTE of 0.5 can indicate half of a full time resource (needed or provided), for example. A FTE job requirement, for instance, may only allow one resource (e.g., employee) allocated to at most one job (e.g., position).

In order to increase resource utilization, FTE job requirements can be satisfied (e.g., “solved”) using a single comprehensive mathematical optimization solver. The FTE job requirements can be solved by mathematical optimization solvers such as, for example, gurobi optimization and/or other specialized methods that solve the assignment problem.

Resources of an enterprise may have fractional capacity. Fractional capacity can include an availability for a job that is less than a FTE amount (e.g., less than 1). Currently, a resource manager can define a number of positions, and an amount of capacity required by each of the number of positions, for each FTE job requirement. Using such an approach, the resource manager makes a decision on how to partition (e.g., split) a FTE job requirement into a plurality of positions to be filled by a resource. To make this decision, the resource manager may require an understanding of fractional resource capacity of available resources.

For example, consider a FTE job requirement of 2.4 electricians. The resource manager may decide to split this FTE job requirement into three positions of 0.8 capacity for each position (e.g., three times 0.8 equals 2.4). If there are 12 resources (employees) with 0.5 capacity available, then resource planning may declare a gap of 2.4 electricians. A gap, as used herein, can include a job requirement that cannot be filled by a current resource. This scenario may result in six units of idle capacity (e.g., 12 resources times 0.5 capacity equals six). Had the resource manager partitioned the FTE requirement into six positions at 0.4 capacity, then the FTE job requirement can be filled with the six positions and resource utilization can be increased.

In contrast, in examples in accordance with the present disclosure resource planning can include utilizing a mathematical model that can partition FTE job requirements into a plurality of positions based on fractional resource capacity of an available resource pool. A resource pool can include a plurality of resources associated with an enterprise. The plurality of available resources can be prioritized based on lowest cost to match to the positions (e.g., as discussed further herein). Partitioning FTE job requirements based on fractional resource capacity can result in higher resource utilization as compared to a resource manager determining partitioning of FTE job requirements.

Examples of the present disclosure may include methods, systems, and computer-readable and executable instructions and/or logic. An example method for partitioning a job requirement for resource planning can include identifying resource capacity and matching scores of a resource pool for a resource planning horizon, partitioning a FTE job requirement into a plurality of positions based on the resource capacity and matching scores of the resource pool for the resource planning horizon, and performing resource planning by allocating the resource capacity to the plurality of positions.

As used herein, an enterprise may be a business entity, but need not be limited to an entity having a commercial intent. Resources can refer to human and non-human resources, such as people, equipment, buildings, vehicles, services, assets, and the like. For example, resources may include employees, computer processing capability at a particular time or over some period of time (e.g., resource planning horizon), data storage hardware, and/or office space used by an organization, among others.

As used herein, a job can include any function to which a resource can be assigned. For example, a job can be an employment situation, such as a professional services position that may be associated with a business entity or project associated with the business entity. A job can also be a task performed by an apparatus. For example, a job can be data storage performed by a storage device (e.g., memory), or a job can be a batch processing performed by one or more processors.

As used herein, a position can include a FTE and/or fractional FTE job for a particular project in a period of time. A project can include a business plan to achieve a particular result. A project can consist of a plurality of FTE requirements over a plurality of time. As an example, an enterprise associated with a project to build a school can include a plurality of electrician jobs and a plurality of plumber jobs in 2 year time period.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, “a number of” an element and/or feature can refer to one or more of such elements and/or features.

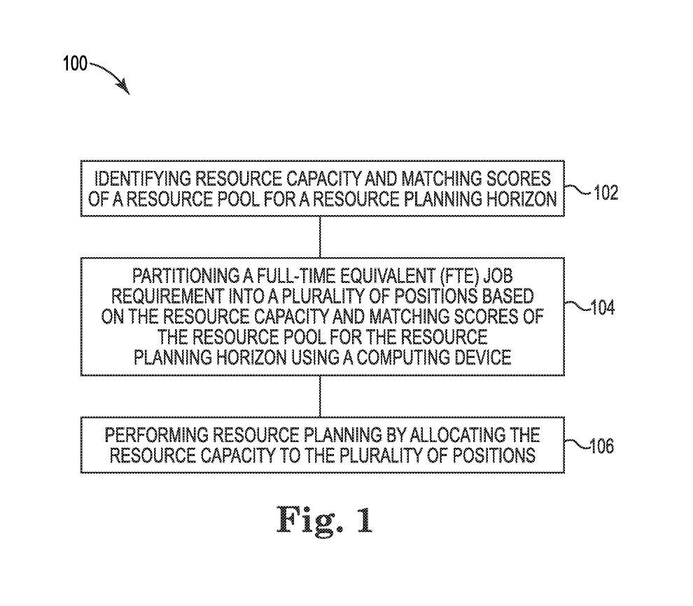

FIG. 1 is a block diagram illustrating an example of a method 100 for partitioning a job requirement for resource planning according to the present disclosure. The method 100 can be used to partition a plurality of FTE job requirements into a plurality of positions to improve resource utilization.

At 102, the method for partitioning a job requirement for resource planning can include identifying resource capacity and matching scores of a resource pool for a resource planning horizon. A resource pool, as used herein, can include a plurality of resources associated with an enterprise.

A resource capacity can include resource(s) available over the resource planning horizon and can include information describing an FTE capacity and matching scores of various resources available during the resource planning horizon. Matching scores, as used herein, can include a resource's ability to perform a particular task (e.g., job) and a resource's availability to perform the particular task (e.g., as discussed further herein).

For example, a resource capacity can include an available capacity of a particular resource for a job. The identification can be performed by a computing device (e.g., a computer). For example, resource capacity can be identified via user input, it can be retrieved from a computer database, and/or it can be identified through data mining, among other ways.

In some examples, a resource capacity for a particular resource may include an available capacity for multiple jobs over a plurality of time periods in the resource planning horizon. The resource planning horizon can include a total time for the current resource planning performed. The plurality of time periods can include a plurality of periodic times (e.g., time periods) within the resource planning horizon. For instance, a resource planning horizon can include 3 years and a plurality of time periods can include year 1, year 2, and year 3. A particular resource may have an available capacity and a matching score for multiple jobs in multiple time periods within the resource planning horizon.

An available capacity for a particular resource can include a fractional resource capacity. A fractional resource capacity, as used herein, can include an availability of a particular resource for a particular FTE job requirement that is less than FTE. For example, a fractional capacity can include a number that is less than 1.0 FTE. For instance, a particular resource with an available capacity of 0.5 for a job can indicate half of a full time resource. Thereby, identifying a resource capacity for a resource pool can include identifying fractional capacity for a plurality of resources for a plurality of jobs over a plurality of time periods in a resource planning horizon.

At 104, the method 100 for partitioning a job requirement for resource planning can include partitioning a FTE job requirement into a plurality of positions based on the resource capacity and matching scores of the resource pool for the resource planning horizon using a computing device. Partitioning a FTE job requirement into a plurality of positions can include addressing a FTE job requirement, resource capacity, and matching scores of a resource pool to partition the FTE job requirement into positions and mapping the positions to resources with available capacity in the resource pool.

Partitioning a FTE job requirement into a plurality of positions, in some examples of the present disclosure, can include determining a capacity requirement of each position, a duration of each position, and time periods in the resource planning horizon that each position is open. For example, assume there is 4 time periods (t1, t2, t3, t4) in a resource planning horizon and assume a FTE job requirement of 1 at each period (e.g., 1,1,1,1). Further, assume there are two employees (e.g., resources) e1 and e2 with available capacity (1,1,0,0) and (0,0,1,1) respectively. Partitioning the FTE job requirement will generate two positions s1 (1,1,0,0) and s2 (0,0,1,1), where the duration of position 1 is 2 time periods (t1 and t2), and duration of position 2 is also 2 time periods but at different periods (t3 and t4).

In various examples, partitioning a FTE job requirement can include partitioning a plurality of FTE job requirements into a plurality of positions. For instance, the partitioning of a plurality of FTE job requirements can be based on fractional capacity and matching scores of a resource pool and FTE job requirements for the resource planning horizon. Utilizing a mathematical function, the FTE job requirements can be partitioned based on the fractional capacity to avoid and/or minimize gaps in FTE job requirements while maximizing the total matching score of the assignment.

At 106, the method 100 for partitioning a job requirement for resource planning can include performing resource planning by allocating the resource capacity to the plurality of partitioned positions. Allocating the resource capacity can include filling the partitioned positions with resources with available capacity for the position. Resource planning can include utilizing a mathematical resource planning model (e.g., a function) to allocate resources to partitioned positions, in various examples, by minimizing idle resources (e.g., resources not used to fill a FTE in a given resource planning horizon) while maximizing matching scores (e.g., as discussed further herein). For instance, resource planning can include generating a resource plan including the allocation of the resource capacity to the plurality of partitioned positions while maximizing the total matching score of the assignment.

In some examples of the present disclosure, the resource plan (e.g., allocated resources capacity to the plurality of positions) can be used in the method 100 for calculating revenue generated by a resource in the resource planning horizon based on the resource planning. For instance, an enterprise can determine revenue generated by each resource allocated to a position using the resource plan based on the project and job that the position is associated with. For instance, assume employee A is allocated to an electrician position for a project to build a school. The enterprise can calculate revenue generated by employee A based upon the total revenue of the project and the FTE time associated with the project allocated to employee A.

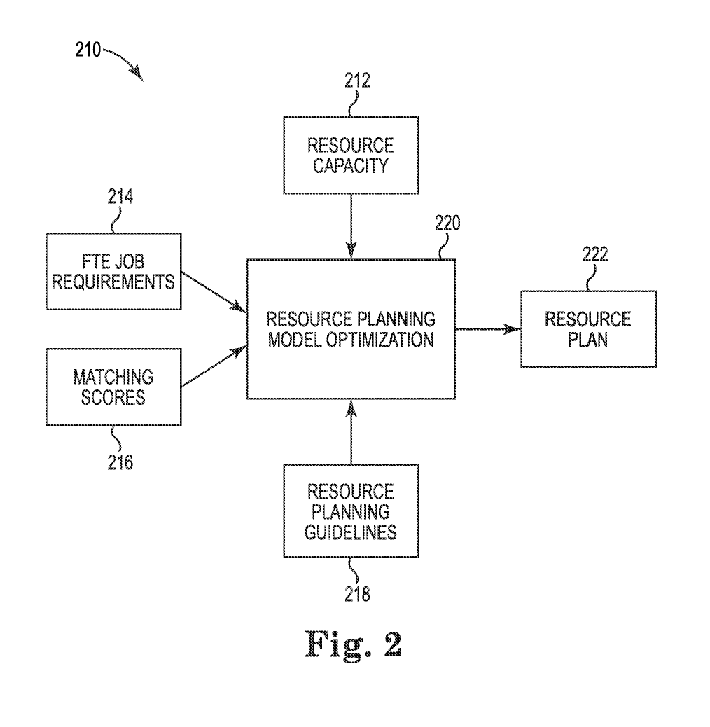

FIG. 2 is a flow chart illustrating an example of a process 210 for partitioning job requirements for resource planning. The process 210 can include generating a mathematical resource planning model (e.g., a function) to partition FTE job requirements into a plurality of positions based on resource capacity of a resource pool.

For example, a resource capacity of a resource pool can be considered at 212. A resource capacity of a resource pool can include identification of a capacity for jobs for a plurality of resources in a given period of time. In various examples, a particular resource may be available for a plurality jobs in a period of time. In such an instance, a priority may be identified for the plurality jobs. For instance, a particular job may be considered more important than another. A job may be more important, for example, due to higher revenue and/or profit from the job, higher cost to fill a gap with a new resource, and/or a project and/or job may have strategic value for an enterprise. The priority of the plurality jobs can be used to allocate the resources. For instance, an objective function of the resource planning model can capture prioritization of jobs and/or projects.

At 214, FTE job requirements can be considered. For the resource planning model, it can be assumed that the FTE job requirement is defined as a one resource capacity requirement. If the FTE job requirements is 1 than it can require one resource working the job 100 percent of his/her capacity. However, if the FTE job requirement is fractional (e.g., less than one or greater than 1), it can require a resource working on the job less than 100 percent of his/her capacity. In a fractional situation, the resource may be allocated to other jobs with the leftover capacity available.

At 216, matching scores can be considered. Matching scores, as used herein, can include a resource's ability to perform a particular task (e.g., job) and a resource's availability to perform the particular task. For instance, matching scores can include a calculated score identifying the qualification of a particular resource for a particular job. The matching score can consider the cost of matching the resource to the particular task (e.g., cost of training, cost of using a qualified employee, cost of hiring a new resource, etc.) Optimizing the resource planning model can include maximization of a weighing factor of the matching score while minimization of idle resources (e.g., through partitioning of FTE job requirements). In various examples, matching scores include an objective function of the resource planning model (e.g., as discussed further herein).

At 218, resource planning guidelines can be considered. Resource planning guidelines can include objective functions of the resource planning model. For example, objective functions can include a number of optimization objectives and/or allocation business rules. For example, a project manager may express a preferences for a particular resource (e.g., employee) to fill a certain type of job (e.g., pre-allocation preferences), and the pre-allocation preference can be honored so long as the allocation is not sub-optimal to other optimization objectives. An example optimization objective can include minimizing total gaps in FTE job requirements while maximizing a total matching score of an assignment.

Allocating the most qualified resource to a particular FTE job requirement may be an optimization objective. For example, a matching score that defines a resource's ability (e.g., qualifications) to perform a particular task can be computed between job requirements and resource qualifications. Another optimization objective, for example, may be a capacity availability of resources. A resource can be allocated to a job with the resource capacity available exactly matching the FTE job requirement to avoid a shortage of capacity or idle capacity. In an example, a particular job may be considered more important than another job. For example, a particular project and/or job may result a higher revenue and profit than another project, and other projects may have strategic value for a company. The objective function of the resource planning model can capture this priority of projects, for example.

A resource planning model can have a number of constraints. For example, the model can include demand constraints and resource constraints. For each partitioned position, a demand constraint can include identify a qualified resource and/or declare a gap for that job. For each resource, the resource constraint can identify the set of jobs that the resource is qualified for, compute the associated matching score and/or allocate at most one job to such resource based on the resource capacity available and the matching score, for example.

In addition, a resource planning model can have a consistency constraint. A consistency constraint can include a requirement that a resource allocated to a job in a period of time continues the job until the position ends, the resource planning horizon is completed, and/or the resource has insufficient available capacity. Thereby, if there is an open position, once a resource (e.g., employee) starts (e.g., fills) the position the resource will continue in the position (e.g., continue doing the job) without interruption until the end of the position, the end of resource planning horizon, and/or until the resource does not have enough capacity to fill the position.

Further, a resource planning model can have a partitioning constraint and a resource capacity constraint. For instance, a partitioning constraint can include a threshold number of partitioned positions for a particular job (e.g., a FTE job requirement associated with a project and a job). For instance, the threshold number can include a maximum number of positions a FTE job requirement can be partitioned into. Such a constraint can assist in avoiding partitioning jobs into meaningless job requirements. A resource capacity constraint, in various examples, can include a threshold resource capacity to fill a position (e.g., a minimum resource capacity requirement). If a particular resource has an available capacity for a position below the threshold, the resource may not be allocated to the position.

At, 220 a resource planning model for the resource planning horizon can be generated and optimized. The resource planning model can include a number of indices. For example, wεW can include an index and set of resources, (j,i)εJI can include an index and set of job requirements (e.g., jobs required by a project l), tεT can include time period in a resource planning horizon, s include a position counter, and jistεJIST can include an index referring to a position s of job j required by project l at a period of time t and can be referred to as a “position,” where JIST is a set of such valid indices.

Input parameters of the resource planning model can include, for example, m(j,i), FTE_{j,i,t}, D_{j,i}^{min}, K_{w,t}, ms(w,ji), πᵢ, and ε. m(j,i) can include a maximum number of positions that can be used to fill job requirement ji. FTE_{j,i,t} can include FTE job requirement ji at time period t. In an example, whenever a resource filling a job requirement ji at period t is required full time, then the FTE requirement is 1. D_{j,i}^{min} can include a minimum resource capacity required to fill job requirement ji. K_{w,t} can include a capacity of resource w available at time period t. In an example, whenever the resource is fully available the capacity available is 1. ms(w, ji) can include a matching score of resource w if filling job requirement ji. In an example, whenever the resource filling a job requirement ji is a perfect match the matching score is 1. πᵢ can include a gap penalty for not filling FTE requirements of project i, and ε can include a penalty for splitting a FTE job requirement into a plurality of positions.

The resource planning model can include a plurality of decision variables. Decision variables can include, for example, an amount of capacity of resource w at time t allocated to fill position s of job ji is greater than or equal to 0 and less than or equal to the capacity available for resource w at time t (e.g., 0≦x_{w,j,i,s,t}≦K_{w,t}). An amount of FTE job requirement jit allocated to position s at time t is greater than or equal to 0 and less than or equal to 1 (e.g., 0≦z_{j,i,s,t}≦1). If position s of job requirement ji is open during time t then y_{j,i,s,t} is 1, otherwise y_{j,i,s,t} is 0 (e.g., y_{j,i,s,t}ε{0,1}). If resource w is allocated to satisfy position jis at time t then is u1_{w,j,i,s,t} is 1, otherwise u1_{w,j,i,s,t} is 0 (e.g., u1_{w,j,i,s,t}ε{0,1}). If resource w is allocated to position jis throughout planning horizon T then u_{w,j,i,s} is 1, otherwise u_{w,j,i,s} is 0 (e.g., u_{w,j,i,s}ε{0,1}). 0≦v_{w,j,i,s,t}≦1 is an auxiliary variable to linearize the product of (u*z) wherein v=z if u=1, otherwise v=0 if u=0. Gap (e.g., unfulfilled demand) of job ji during time t is greater than or equal to 0 and less than or equal to the FTE job requirement of job ji at time t (e.g., 0≦gap_{j,i,i}≦FTE_{j,i,t}).

An objective function of the resource planning model can entail minimizing total penalties associated with partitioning a plurality of FTE job requirements into a plurality of positions, total penalties associated with allocating a resource to a partitioned position that is not 100 percent qualified, total penalty of gaps, and total penalties associated with opening a position at a period of time. In addition, the objective function can satisfy constraints and/or resource planning guidelines. For example:

$$Min Penalties = {\sum }_{( w , ji ) ∈ WIJI} ( 1 - ms ( w , ji ) ) * {\sum }_{t ∈ T} {\sum }_{s = 1}^{m ( i , j )} {x}_{w , jis , t} + {\sum }_{jit} {π}_{i} * {gap}_{jil} + ɛ * {\sum }_{( j , i , t ) ∈ JIT} {\sum }_{s = 1}^{m ( j , i )} {y}_{ji , st , t} .$$

The resource constraint can ensure that each resource is at most allocated to one position. For each wεW, the following can be satisfied:

$${\sum }_{jis ∈ JIS} {u}_{w , jis} \leq 1.$$

To solve the resource planning model (e.g., optimize the resource planning model at 220), resources can be allocated with fractional capacity to partitioned positions. Solving the resource planning model can include ensuring constraints and/or objectives of the models are satisfied.

The demand constraint can ensure that either a FTE job requirement is filled by generating a position that will be filed by a resource or that a gap is declared. For instance, partitioning FTE job requirements into positions can include:

$${\sum }_{s = 1}^{m ( j , i )} {z}_{j , i , s , t} + {gap}_{j , i , t} = F T {E}_{j , i , t} .$$

If position jist is open, than the FTE job requirement can allocated to the position, for example:

z_{j,i,s,t}≦y_{j,i,s,t}.

The partitioning constraint can ensure that a FTE job requirement is not partitioned into meaningless positions (e.g., less than a threshold number of positions). Partitioned positions may be required to satisfy a minimum capacity (e.g., partitioning constraint). For each (j,i,s)εJIS, the following can be satisfied:

D_{j,i}^{min}*y_{j,i,s,t}≦z_{j,i,s,t}.

A position jist can be filled by resource wand can be denoted by:

$${\sum }_{w ∈ W} {x}_{w , j , i , s , t} = {z}_{j , i , s , t} .$$

And, for each position (e.g., jist) filled, a resource constraint can ensure that each resource is at most allocated to one position. For each wεW, the following can be satisfied:

$${\sum }_{w ∈ W} u {1}_{w , jis , t} = {y}_{jis , t} .$$

For instance, if x>0 than u1=0 and u1_{w,jis,t}≧x_{w,jis,t}. Further, if u1=1, then x<0 and u1_{w,jis,t}≦(1/D_{i,j}^{min})*x_{w,jis,t}.

A resource capacity constraint can ensure that a resource w has enough capacity to fill the requirements of the position jis that is allocated at time period t. For each wεW and time period t, the following can be satisfied:

$${\sum }_{jis} {x}_{w , jis , t} \leq {K}_{w , t} .$$

A consistency constraint can ensure that a resource w is allocated to a position jis is over a subset of continuous time periods of the resource planning horizon T. For each wεW, the following can be satisfied:

$${\sum }_{t ∈ T} {x}_{w , jis , t} = {u}_{w , jis} * {\sum }_{t ∈ T} {z}_{jis , t} , \\ wherein$$

$${\sum }_{t ∈ T} {x}_{w , jis , t} = {\sum }_{t ∈ T} {v}_{w , jis , t} .$$

In addition, a plurality of logic constraints can be satisfied to ensure that the consistency constraints are linear. Example logic constraints can include:

v_{w,jis,t}≧z_{jis,t}−(1−u_{w,jis}),

v_{w,jis,t}≦u_{w,jist}, and

v_{w,jis,t}≦z_{jis,t}.

In some examples, solving the resource planning model can include optimizing a global demand fulfillment metric, a global resource utilization metric, and a global matching score metric. A global demand fulfillment metric can be defined as a ratio of a number of positions fulfilled with respect to a total number of positions required (e.g., the partitioned FTE requirements). The optimal value of this metric can be 1, which means that all positions requirements are satisfied completely. In an example, the number of positions filled is equal to the total number of positions required minus the number of positions that could not be filled at all; the global demand fulfillment metric can defined as follows:

$$Global Demand Fulfillment = ( 1 - \frac{{\sum }_{jis} {gap}_{jis}}{{\sum }_{jis} ( F T E - req )} ) .$$

A global resource utilization metric can be defined as a ratio between the resources allocated to fill job requirements with respect to the total number of resources. The optimal value of this metric can be 1, meaning all resources can be allocated to fill positions (e.g., with 100% capacity). For example, a resource w can be idle if he or she was not allocated to fill any position or if resource w has fractional resource capacity available (e.g.,

$${\sum }_{jis} {u}_{w , jis} = 0 ) .$$

A set of idle resources can include:

$$IDLE = \{ w ∈ W : {\sum }_{jis ∈ JIS} {u}_{u , jis} = 0 \} ,$$

and as a result, the number of resources allocated to fill positions can be equal to the total number of resources-minus the total number of resources that are idle. The global resource utilization metric can be computed as follows:

$$Global Resource Utilization = ( 1 - \frac{{\sum }_{w ∈ IDLE} {1}_{w}}{{\sum }_{w ∈ W} {1}_{w}} ) .$$

A global matching score metric can be defined as a ratio of the total matching scores of resources allocated to fill positions with respect to a matching, (e.g., “perfect” matching) for all positions required. The optimal value of this metric can be 1, meaning that all positions can be filled with matching, (e.g., perfect matching) resources. The global matching score metric can be computed as follows:

$$Global Matching = ( \frac{{\sum }_{( w , jist ) ∈ WJIST} ( {ms}_{w , ji} * x )}{{\sum }_{jis} ( F T E )} ) .$$

The resource planning model can be optimized using the plurality of resource guidelines (e.g., objectives and constraints) to allocate the fractional resource capacity to the plurality of positions for resource planning, at 222 (e.g., a resource plan). The resource plan can be used to provide workforce resources with desired skills for the appropriate job at the appropriate time and cost. The resource plan can be determined, for instance, by using a mathematical optimization solver.

In various examples, an open position constraint can be satisfied to remove symmetrical solutions. Positions can be opened, in various examples, in a particular order. The particular order can include from 1 to m(i,j). The open position constraint can ensure that positions are opened in a sequenced fashion so as to remove symmetrical solutions. For instance, a position (e.g., s+1) cannot be opened (e.g., y(ji,s+1,t)=1) until position s is opened. For each position, the following can be satisfied:

y_{j,i,s+1,t}≦y_{j,i,s,t}.

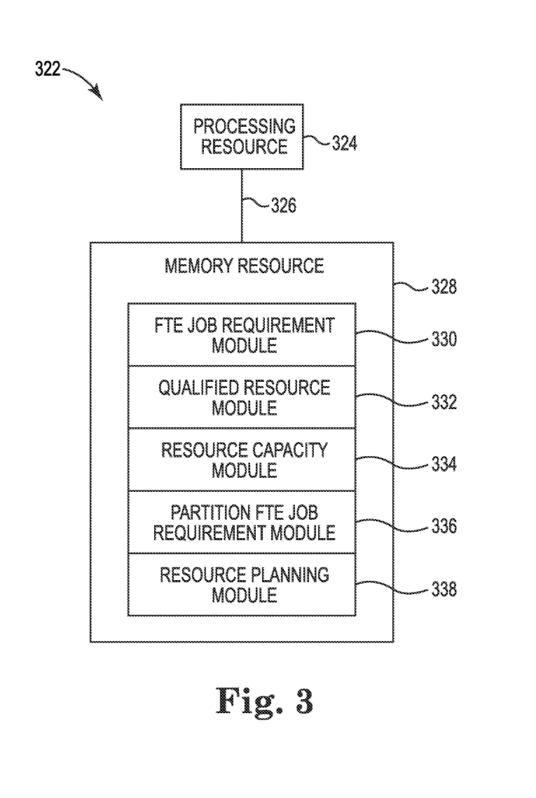

FIG. 3 illustrates a block diagram of an example of a system 322 according to the present disclosure. The system 322 can utilize software, hardware, firmware, and/or logic to perform a number of functions.

The system 322 can be any combination of hardware and program instructions configured to partition FTE job requirements into a plurality of positions for resource planning. The hardware, for example, can include a processing resource 324, a memory resource 328, and/or computer-readable medium (CRM) (e.g., machine readable medium (MRM), database, etc.) A processing resource 324, as used herein, can include any number of processors capable of executing instructions stored by a memory resource 328. Processing resource 324 may be integrated in a single device or distributed across devices. The program instructions (e.g., computer-readable instructions (CRI)) can include instructions stored on the memory resource 328 and executable by the processing resource 324 to implement a desired function (e.g., identify a plurality of FTE job requirements for a resource planning horizon, etc.).

The memory resource 328 can be in communication with a processing resource 324. A memory resource 328, as used herein, can include any number of memory components capable of storing instructions that can be executed by the processing resource 324. Such memory resource 328 is non-transitory CRM. Memory resource 328 may be integrated in a single device or distributed across devices. Further, memory resource 328 may be fully or partially integrated in the same device as processing resource 324 or it may be separate but accessible to that device and processing resource 324. Thus, it is noted that the system 322 may be implemented on a user and/or a client device, on a server device and/or a collection of server devices, and/or on a combination of the user device and the server device and/or devices.

The processing resource 324 can be in communication with a memory resource 328 storing a set of CRI executable by the processing resource 324, as described herein. The CRI can also be stored in remote memory managed by a server and represent an installation package that can be downloaded, installed, and executed. The system 322 can include memory resource 328, and the processing resource 324 can be coupled to the memory resource 328.

Processing resource 324 can execute CRI that can be stored on an internal or external memory resource 328. The processing resource 324 can execute CRI to perform various functions, including the functions described with respect to FIG. 1 and FIG. 2. For example, the processing resource 324 can execute CRI to optimize resource utilization of the plurality of resources for resource planning based on the partitioned plurality of positions and resource qualification of each resource.

The CRI can include a number of modules 330, 332, 334, 336, 338. The number of modules 330, 332, 334, 336, 338 can include CRI that when executed by the processing resource 324 can perform a number of functions.

The number of modules 330, 332, 334, 336, 338 can be sub-modules of other modules. For example, the partition FTE job requirement module 336 and the resource planning module 338 can be sub-modules and/or contained within the same computing device. In another example, the number of modules 330, 332, 334, 336, 338 can comprise individual modules at separate and distinct locations (e.g., CRM, etc.).

A FTE job requirement module 330 can include CRI that when executed by the processing resource 324 can provide a number of FTE job requirement functions. The FTE job requirement module 330 can identify a plurality of FTE job requirements for a resource planning horizon. The plurality of FTE job requirements can include fractional requirements for a plurality of time periods in the resource planning horizon. Each FTE job requirement can, for instance, be associated with a project.

For instance, an enterprise may have FTE job requirements for an electrician for a first project and a second project in a resource planning horizon. The first project may require an electrician in a first time period and a second time period. The second project may require an electrician in a second time period and a third time period. Although the present example illustrates a single job for two projects in three time periods, examples in accordance with the present disclosure are not so limited. For instance, a resource plan for an enterprise in a resource planning horizon can include a plurality of jobs for a plurality of projects in a plurality of time periods.

A qualified resource module 332 can include CRI that when executed by the processing resource 324 can perform a number of matching qualified resource functions. The qualified resource module 332 can match a plurality of qualified resources in a resource pool with the plurality of FTE job requirements based on matching scores. A qualified resource, as used herein, can include a resource with availability for a FTE job requirement. For instance, in some examples, matching qualified resources can include instructions to map the FTE job requirements to qualified resource(s) (e.g., based on a matching score) with available capacity in the resource pool.

A resource capacity module 334 can include CRI that when executed by the processing resource 324 can perform a number of resource capacity functions. The resource capacity module 334 can identify a fractional resource capacity for the plurality of qualified resources over a plurality of time periods in the resource planning horizon.

A partition FTE job requirement module 336 can include CRI that when executed by the processing resource 324 can perform a number of partitioning functions. The partition FTE job requirement module 336 can partition the plurality of FTE job requirements into a plurality of positions based on the fractional resource capacity and matching scores of the plurality of qualified resources. Partitioning a plurality of FTE job requirement into a plurality of positions, in some examples of the present disclosure, can include determining a capacity requirement of each position, a duration of each position, and time periods in the resource planning horizon that each position is open. The partitioning can, for instance, be determined using optimization of a resource planning model.

A resource planning module 338 can include CRI that when executed by the processing resource 324 can perform a number of resource planning functions. The resource planning module 338 can optimize resource utilization of the plurality of resource based on the partitioned plurality of positions and matching score of each resource. A matching score can, for instance, include a matching score of a particular resource with a particular job. The resource plan can include allocating the plurality of resources to the partitioned plurality of positions based on the matching score of each qualified resource.

In some examples, the resource planning module 338 can include instructions to satisfy a consistency constraint for resource planning. A consistency constraint can include a constraint to ensure a resource allocated to a position can continuously fill the position for a subset of the resource planning horizon. For example, a consistency constraint can be satisfied by instructions to verify each qualified resource allocated to a position has continuous available capacity for the position throughout a subset of time periods within the resource planning horizon.

A memory resource 328, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 328 can be integral, or communicatively coupled, to a computing device, in a wired and/or a wireless manner. For example, the memory resource 328 can be an internal memory, a portable memory, a portable disk, or a memory associated with another computing resource (e.g., enabling CRIs to be transferred and/or executed across a network such as the Internet).

The memory resource 328 can be in communication with the processing resource 324 via a communication path 326. The communication path 326 can be local or remote to a machine (e.g., a computing device) associated with the processing resource 324. Examples of a local communication path 326 can include an electronic bus internal to a machine (e.g., a computing device) where the memory resource 328 is one of volatile, non-volatile, fixed, and/or removable storage medium in communication with the processing resource 324 via the electronic bus.

The communication path 326 can be such that the memory resource 328 is remote from the processing resource (e.g., 324), such as in a network connection between the memory resource 328 and the processing resource (e.g., 324). That is, the communication path 326 can be a network connection. Examples of such a network connection can include a local area network (LAN), wide area network (WAN), personal area network (PAN), and the Internet, among others. In such examples, the memory resource 328 can be associated with a first computing device and the processing resource 324 can be associated with a second computing device (e.g., a Java® server). For example, a processing resource 324 can be in communication with a memory resource 328, wherein the memory resource 328 includes a set of instructions and wherein the processing resource 324 is designed to carry out the set of instructions.

The processing resource 324 coupled to the memory resource 328 can execute CRI to identify a plurality of FTE job requirements for a resource planning horizon. The processing resource 324 coupled to the memory resource 328 can also execute CRI to match a plurality of qualified resources in a resource pool with the plurality of FTE job requirements based on matching scores. The processing resource 324 coupled to the memory resource 328 can also execute CRI to identify a fractional resource capacity for the plurality of qualified resources over a plurality of time periods in the resource planning horizon. The processing resource 324 coupled to the memory resource 328 can also execute CRI to partition the plurality of FTE job requirements into a plurality of positions based on the fractional resource capacity and matching scores of the plurality of resources. The processing resource 324 coupled to the memory resource 328 can also execute CRI to optimize resource utilization of the plurality of resources for resource planning based on the partitioned plurality of positions and matching score of each qualified resource.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for partitioning a job requirement for resource planning, comprising:
identifying resource capacity and matching scores of a resource pool for a resource planning horizon;
partitioning a full-time equivalent (FTE) job requirement into a plurality of positions based on the resource capacity and matching scores of the resource pool for the resource planning horizon using a computing device; and
performing resource planning by allocating the resource capacity to the plurality of positions.

2. The method of claim 1, wherein identifying resource capacity includes determining fractional resource capacity for each of a plurality of resources in the resource pool.

3. The method of claim 1, wherein partitioning the FTE job requirement into the plurality of positions includes determining a capacity requirement of each position, a duration of each position, and time periods in the resource planning horizon that each position is open.

4. The method of claim 1, including calculating revenue generated by a resource in the resource planning horizon based on the resource planning.

5. The method of claim 1, including defining a threshold capacity for each of the plurality of positions for the FTE job requirement.

6. The method of claim 1, including defining a threshold number of partitioned positions for the FTE job requirement.

7. A non-transitory computer-readable medium storing a set of instructions executable by a processing resource to:
generate a resource planning model using identified fractional resource capacity of a resource pool and a plurality of full-time equivalent (FTE) job requirements;
partition the plurality of FTE job requirements into a plurality of positions based on the fractional resource capacity and matching scores of the resource pool using the resource planning model; and
allocate the fractional resource capacity to the plurality of positions for resource planning by optimizing the resource planning model using a plurality of resource guidelines.

8. The medium of claim 7, wherein the instructions executable by the processing resource to allocate the fractional resource capacity include instructions to optimize a global resource qualification metric, a global resource utilization metric, and a global matching score metric.

9. The medium of claim 7, wherein the instructions executable by the processing resource to optimize the resource planning model include instructions to optimize a trade-off of the plurality of resource guidelines, wherein the resource guidelines include a plurality of objectives.

10. The medium of claim 9, wherein one of the plurality of objectives includes minimizing total gaps in FTE job requirements while maximizing a total matching score of an assignment.

11. The medium of claim 9, wherein one of the plurality of objectives includes a priority of a job to a particular resource.

12. The medium of claim 7, wherein the instructions executable by the processing resource include instructions to satisfy an open position constraint to remove symmetrical solutions.

13. A system for partitioning positions for resource planning, comprising:
a processing resource; and
a memory resource communicatively coupled to the processing resource containing instructions executable by the processing resource to:
identify a plurality of full-time equivalent (FTE) job requirements for a resource planning horizon;
match a plurality of qualified resources in a resource pool with the plurality of FTE job requirements based on matching scores;
identify a fractional resource capacity for the plurality of qualified resources over a plurality of time periods in the resource planning horizon;
partition the plurality of FTE job requirements into a plurality of positions based on the fractional resource capacity and matching scores of the plurality of qualified resources; and
optimize resource utilization of the plurality of resources for resource planning based on the partitioned plurality of positions and matching score of each qualified resource.

14. The system of claim 13, wherein the instructions executable to match the plurality of qualified resources in the resource pool with the plurality of FTE job requirements include instructions to map the FTE job requirements to qualified resources with available capacity in the resource pool.

15. The system of claim 13, wherein the instructions executable to optimize resource utilization includes instructions to satisfy a consistency constraint to verify a resource allocated to a position has continuous available capacity for the position throughout a subset of time periods in the resource planning horizon.
